(19) United States
(12) Patent Application Publication
(10) Pub. No.: US 2025/0324258 A1
(43) Pub. Date: Oct. 16, 2025

(54) REAL-TIME DETECTION OF UNAUTHORIZED DRONES USING CELLULAR MEASUREMENTS

(71) Applicant: AT&T Intellectual Property I, L.P., Atlanta, GA (US)

(72) Inventors: Yaron Koral, Cherry Hill, NJ (US); Xuan Tuyen Tran, Bridgewater, NJ (US)

(73) Assignee: AT&T Intellectual Property I, L.P., Atlanta, GA (US)

(21) Appl. No.: 18/632,539

(22) Filed: Apr. 11, 2024

(51) Int. Cl. H04W 12/122; H04B 7/185; H04B 17/318; H04B 17/345; H04W 24/08

(52) U.S. Cl. CPC H04W 12/122; H04B 7/18502; H04B 17/318; H04B 17/345; H04W 24/08

(57) ABSTRACT

Aspects of the subject disclosure may include, for example, identifying user equipment (UE) as cellular drones. A list of suspected cellular drones may be generated based on criteria such as received power levels, changes in interference levels when UEs detach from serving cells and attach to neighboring cells, and the like. Suspected cellular drones may be identified as legitimate cellular drones or nonlegitimate cellular drones based on criteria such as the type of subscriber identity module (SIM) card used. Other embodiments are disclosed.

### FIELD OF THE DISCLOSURE

The subject disclosure relates to cellular drone detection.

### BACKGROUND

Using drones with cellular connections can improve drone operations' range, safety, and efficiency. Drones capable of cellular communications are referred to herein as “cellular drones.” Cellular drones have various applications in various fields, including crop monitoring for agriculture, surveying and mapping for construction and mining, search and rescue of missing people, delivery services, and surveillance for law enforcement. Cellular drones may also be used for malicious purposes such as espionage, taking pictures over restricted areas, smuggling contraband to prisons or across borders, or hacking into computer networks by using wireless signals to intercept data or launch denial of service attacks from nearby networks.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a cellular drone communicating with the communication network of FIG. 1 in accordance with various aspects described herein.

FIG. 2B is a block diagram illustrating an example, non-limiting embodiment of a list of possible drones communicating with a serving cell in a communications network in accordance with various aspects described herein.

FIG. 2C is a block diagram illustrating an example, non-limiting embodiment of possible routes taken by one or more cellular devices communicating with a communications network in accordance with various aspects described herein.

FIGS. 2D-2F depict illustrative embodiments of methods in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for identifying cellular drones. Other embodiments are described in the subject disclosure.

One or more aspects of the subject disclosure include a device having a processing system including a processor, and a memory that stores executable instructions that, when executed by the processing system, facilitate performance of operations. The operations may include measuring a received signal power associated with a user equipment attached to a first cellular base station; determining that the received signal power is above a first threshold; detaching the user equipment from the cellular base station; and identifying the user equipment as a drone based at least in part on a change in measured interference that occurs at the first cellular base station when the user equipment is detached from the first cellular base station.

One or more aspects of the subject disclosure include a non-transitory machine-readable medium, comprising executable instructions that, when executed by a processing system including a processor, facilitate performance of operations. The operations may include generating a list of possible cellular drones, wherein the list includes user equipments (UEs) having measured signal powers above a first threshold; and determining at least one UE on the list is a nonlegitimate drone based at least in part on a type of SIM card used by the at least one UE.

One or more aspects of the subject disclosure include a method. The method may include measuring, by a processing system including a processor, a received signal power associated with a user equipment attached to a first cellular base station; determining, by the processing system, that the received signal power is above a first threshold; detaching, by the processing system, the user equipment from the cellular base station; and identifying, by the processing system, the user equipment as a drone based at least in part on a change in measured interference that occurs at the first cellular base station when the user equipment is detached from the first cellular base station.

Additional aspects of the subject disclosure may include wherein the identifying the user equipment as a drone based at least in part on the change in measured interference comprises measuring an increase in interference and comparing the increase in interference to a second threshold; attaching the user equipment to a second cellular base station, and wherein the identifying the user equipment as a drone is further based on a further change in measured interference that occurs at the second cellular base station when the user equipment is attached to the second cellular base station.

Additional aspects of the subject disclosure may include wherein the identifying the user equipment as a drone is further based on a type of SIM card used by the user equipment; and wherein the operations further comprise identifying the drone as a nonlegitimate drone based on the type of SIM card.

Additional aspects of the subject disclosure may include denying communications services to the nonlegitimate drone; providing information regarding the user equipment using an application programming interface (API); reconstructing a travel path of the user equipment; identifying the travel path as a flight path; and wherein the identifying the user equipment as a drone is further based on the identifying the travel path as a flight path.

Because of the risk of misusing drones and because various regulating authorities may disapprove of drones using commercial SIM cards, legitimate cellular drones typically use dedicated SIM cards and may register with authorities and/or communication network service providers and have their cellular drone related activities approved. Nonlegitimate (or illegal) cellular drones, on the other hand, may not register with authorities and/or communication network service providers, and may use commercial SIM cards meant to be used in phones and in other terrestrial cellular applications. These nonlegitimate cellular drones may attempt to have their activities remain hidden by blending in with the many legitimate cellular drones and legitimate terrestrial users. As used herein, the term “SIM card” refers to removable and/or nonremovable subscriber identity modules including physical cards, e-SIM, embedded SIM, or any other device performing as a subscriber identity module.

Various embodiments described herein identify these nonlegitimate drone usage instances, report them, and even offer mitigation actions. Some embodiments distinguish between flying cellular devices and devices on the ground. Some embodiments distinguish between different flying cellular devices (e.g., legitimate vs. nonlegitimate). As the usage of drones increases over the coming years, the capabilities provided by the various embodiments described herein will become increasingly beneficial in terms of security.

Cellular drones can be controlled from a distance and sent on long distance missions (e.g., 30 miles or more). These missions may be nonlegitimate (e.g., illegal) and with malicious intentions such as espionage, taking pictures over restricted areas, smuggling contraband to prisons or across borders, or hacking into computer networks by using wireless signals to intercept data or launch denial of service attacks from nearby the network. For example, there may be specific zones within which unauthorized drone usage is restricted (e.g., jails, government facilities, company headquarters, or military bases), yet, detecting them visually or using dedicated radar detectors remains complicated, expensive, and/or not scalable. Identifying a cellular drone by a communications service provider is relatively straightforward if the cellular drone uses a dedicated SIM card for drones. However, if the cellular drone uses a regular consumer phone SIM card, identifying the cellular drone as a drone or as a nonlegitimate drone is not as straightforward. Various embodiments described herein provide a capability to identify a drone as a cellular drone (legitimate or nonlegitimate) and alert facilities that request the service if such a drone is spotted in their vicinity. For example, in some embodiments, existing cellular measurements may be used in intelligent real-time drone identification algorithms to identify cellular devices as drones, both legitimate and nonlegitimate. Various embodiments may be integrated with third parties through application programming interface (API) exposure to provide monitoring and alerting services.

Various embodiments provide drone (also referred to herein as unmanned aerial vehicle, or UAV) identification components that may include several identification algorithms. Various embodiments may take measurements from a group of cell towers in an area. A UAV may have a unique RF pattern that it uses with the serving cell tower it is connected to and also an RF pattern in which it creates interference with neighboring cells. Generally, a UAV may have stronger RSRP (Reference Signal Received Power) signal measurements than terrestrial cellular devices connected to the same cell tower from the same location.

Concerning the neighboring (non-serving) cells, a UAV may also have unique measurement and interference signatures. Measurements may be performed periodically by the UAV for mobility management (handover and cell-selection), and the interference is caused by the unintended signals from the UAV's data transmission (such as when the UAV sends videos back to the ground station). Due to the high-altitude positions in the air, UAVs have much stronger channel conditions compared to terrestrial users. This may lead to strong uplink interference which results in a significant increase in uplink noise level at the neighboring cells.

As a UAV moves, one may expect increased interference in a group of cells in the area except for the serving cell to which the UAV is connected. When the UAV chooses a different cell (handover from cell A to another cell B), one may expect the uplink interference of the selected cell B to decrease and the uplink interference of the last cell A to increase. Various embodiments utilize these measurements and others to determine that a cellular device is likely to be a cellular drone. Further, various embodiments may use these measurements to estimate a flight path of a cellular drone.

Various embodiments may identify cellular devices as drones regardless of whether they are legitimate or nonlegitimate. Legitimate cellular drones typically use a dedicated SIM card registered for a drone. Accordingly, when there are one or more drones from registered parties (such as a delivery service) connected to the same cell tower as a nonlegitimate drone, various embodiments may remove them from a list of potential nonlegitimate drones (e.g., a list created based on devices with high upload and download signal power).

Once a potentially nonlegitimate drone or drones in a cell tower are narrowed down, various embodiments may employ further techniques to increase the certainty that they are indeed a cellular drone (as opposed to a terrestrial user). For example, a first technique may include initiating a detachment from the network side for the suspected device. In this case, the suspected device may try to connect to a neighboring cell. If the device is indeed a cellular drone, one may expect that the interference level of the newly selected cell tower would decrease. If there is no change, the device may not be airborne during the time of detach and attach.

A further technique to increase detection confidence may include tracking the device's movement. Identifying the device's path may include using historical radio access network (RAN) event records of the device. Events such as SERVICE_REQ or HANDAOVER are usually logged and can be tracked back. Various embodiments may reconstruct the list of cell towers connected to the device. Then, using signal quality measurements, various embodiments may estimate the distance from the cell tower for each reported RAN event record. By aggregating all reports, various embodiments may reconstruct an estimated route and speed of the device along the route. Using this route, various embodiments may lay it over a map with roads. Suppose the route does not align with existing roads (either for vehicles or pedestrians). Instead, a movement appears more like a path traveled through the air, increasing the confidence that the device is a drone.

Various embodiments may perform or provide mitigation actions when a nonlegitimate drone is suspected. For example, once the identity of the UAV is detected, the network and the customer may get an alert so they can respond to it locally. Also, in some embodiments, the report may include the route history of the UAV, which can reveal its origin. This can be helpful for law enforcement if they identify a source of the illegal drone operations center.

Various embodiments may also provide an option to shut down communication, block specific TCP/UDP ports, or significantly rate limit communications with the drone. Blocking TCP/IP ports can help interfere with a drone for spying reasons that transmit video streams at the target location. Rate limiting has a similar effect and can support when data exfiltration from a target is using a port that cannot be blocked, yet since the UAV is trying to exfiltrate a large amount of data, limiting the bandwidth would make it require too much time. Note that a drone has limited power to sustain its operations. Shutting down communication may cause unwanted results, such as having the drone crash in a populated area, but it can still be a good action in some cases.

As further described below, the presence of a UAV (one or more) may be detected by measuring increased uplink interference in neighboring non-serving cells. The serving cell's identity can be identified by observing a cell with low uplink interference while neighboring cells experience high uplink interference. The identity of the UAV may be identified by looking at the group of cellular devices connected to the serving cell tower and choosing those with the highest RSRP levels. There may be more than one device suspected as the UAV based on their signature. Still, if the UAV handovers to a nearby cell tower, a similar procedure can be done to identify the UAV at the new cell. Matching the time when the handover happened would narrow it down to the specific UAV identity.

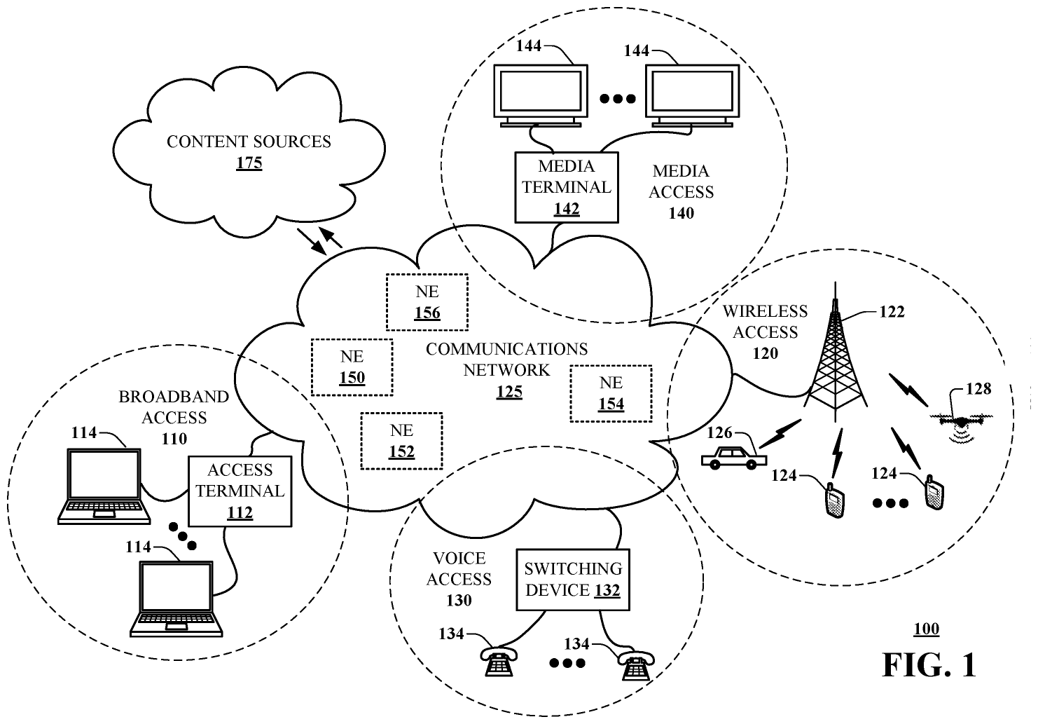

Referring now to FIG. 1, a block diagram is shown illustrating an example, non-limiting embodiment of a system 100 in accordance with various aspects described herein. For example, system 100 can facilitate in whole or in part the identification of cellular drones. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, Internet of Things (IoT) devices, and/or other mobile computing devices. Mobile device 126 may be a connected automobile, and mobile device 128 may be a cellular drone. Mobile devices 124, 126, and 128 are collectively referred to as user equipment (UE) or user equipments (UEs).

Various embodiments described herein provides methods and apparatus to identify one or more of mobile devices 124, 126, and 128 as cellular drones, and to further identify cellular drones as legitimate drones or nonlegitimate drones. For example, one or more network elements within communications network 125 may identify a UE as a cellular drone by comparing a received power level to a threshold, detaching a UE from a cellular base station (e.g., base station 122), and measuring changes in interference levels, reattaching a UE to a different base station and measuring changes in interference levels, determining a type of subscriber identity module (SIM) card used by a UE, a reconstructed path of the UE, and the like.

In some embodiments, an application programming interface (API) is provided to allow users of communications network 125 to interact with network elements that identify drones. For example, a user (e.g., a corporate user with concerns about unauthorized drones in the vicinity, or a government user with similar concerns about drones in a certain geographic area) may set parameters regarding drone identification and may request notification if/when drones satisfying the parameters are identified. As a nonlimiting example, a user may request drone identifications within a radius of a point or within a geofenced area and may also request notification of the existence of drones (legitimate, nonlegitimate, or both) that satisfy the specified criteria. Further, the user may specify an action to be taken when drones are identified (e.g., disable WiFi on legitimate drones, and completely disconnect nonlegitimate drones). These and other embodiments are further described below.

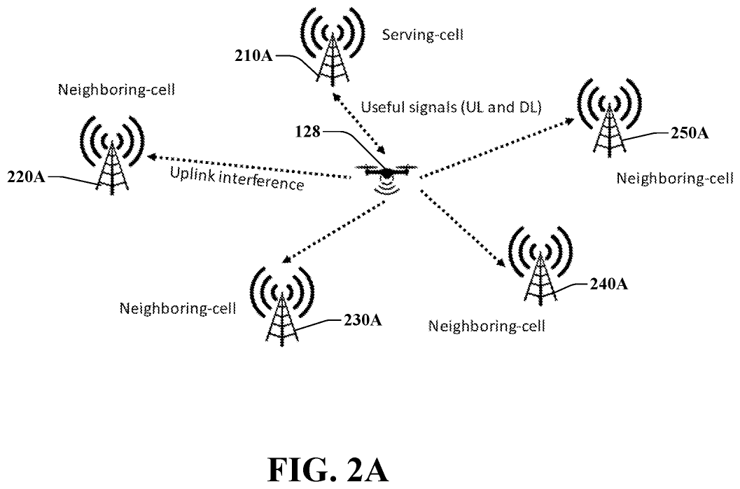

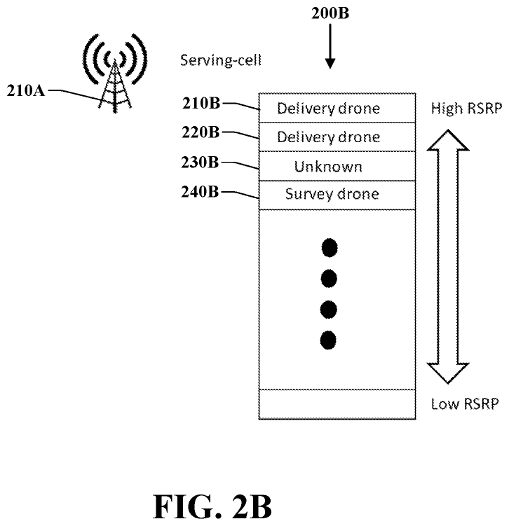

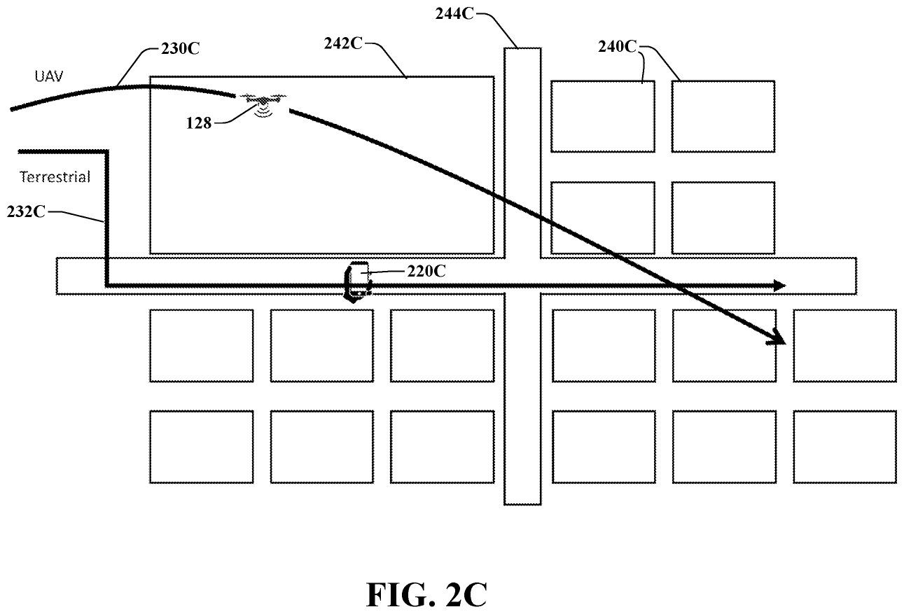

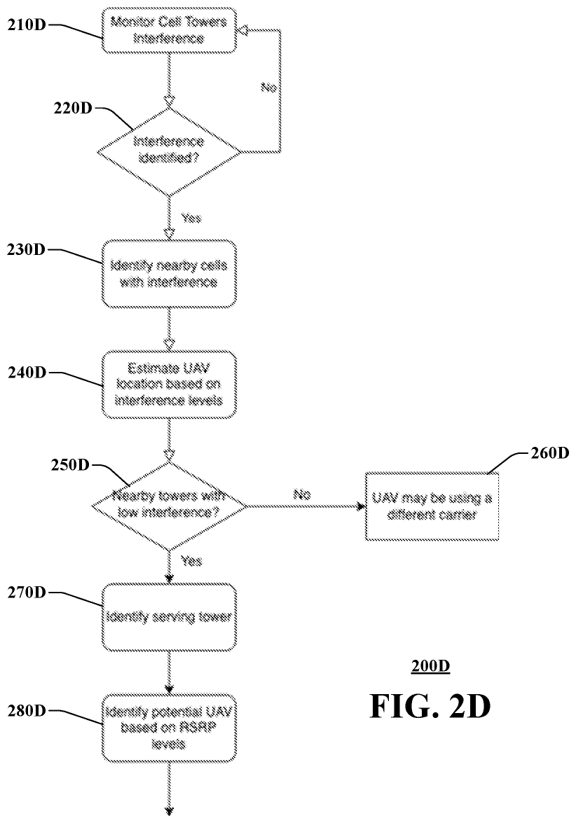

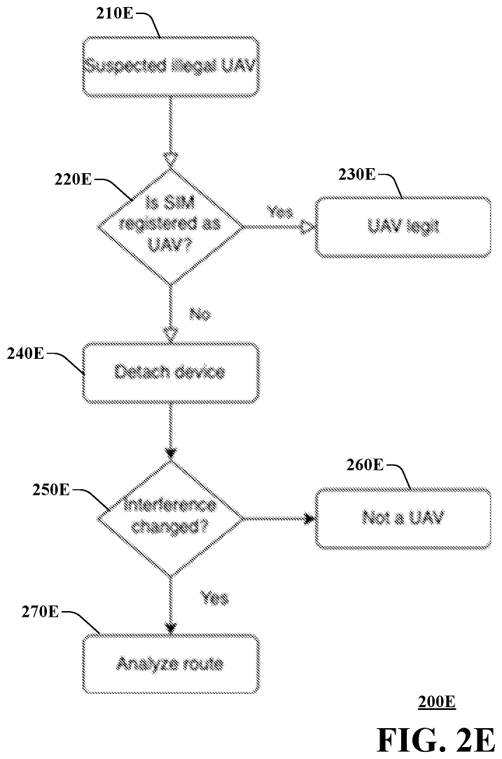

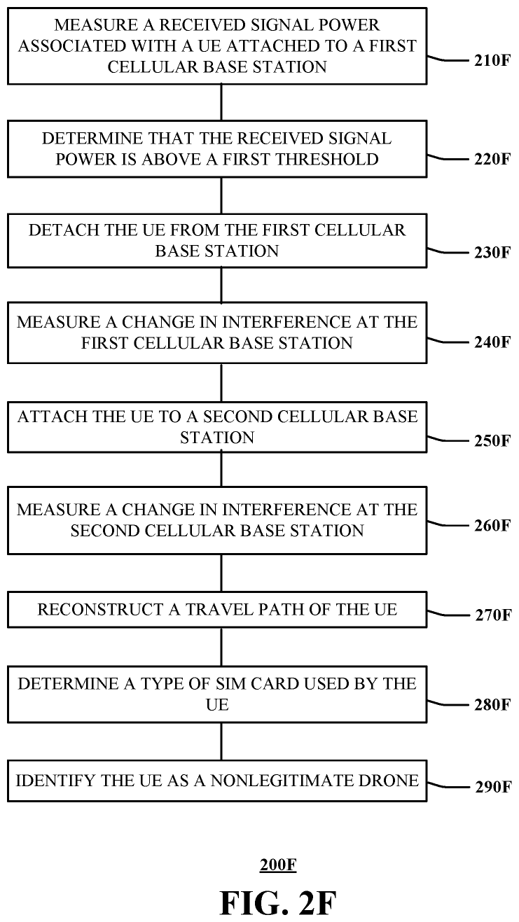

FIG. 2A is a block diagram illustrating an example, non-limiting embodiment of a cellular drone communicating with the communication network of FIG. 1 in accordance with various aspects described herein. FIG. 2A shows cellular drone 128 in communication with serving cell 210A. Serving cell 210A is a cellular base station, such as base station 122 (FIG. 1). Also shown in FIG. 2A are neighboring cells 220A, 230A, 240A, and 250A.

When drone 128 communicates upload and download signals with serving cell 210A, the upload and download signals are received by neighboring cells 220A, 230A, 240A, and 250A as interference. Further, a serving cell may receive signals from drone 128 with a power level that is generally higher than other terrestrial UEs. For example, serving cell 210A may measure reference signal received power (RSRP) of each UE and compare it to a threshold value. The threshold value may be determined as a value that is generally higher than RSRP values for terrestrial UEs, such that when a UE with a RSRP above the threshold is identified, the likelihood that that UE is a drone increases. In some embodiments, serving cell 210A, or a network element within communications network 125 that is in communication with serving cell 210A, compares RSRP of all attached UEs to a threshold value and creates a list of UEs that have an RSRP above the threshold value. This list is referred to as a list of possible cellular drones.

In some embodiments, a network element within communications network 125 may determine that interference levels at neighboring cells 220A, 230A, 240A, and 250A are higher than interference levels at serving cell 210A. Because cellular drones generally have a better line of sight to multiple base stations as compared to terrestrial UEs, cellular drones cause higher interference (as compared to interference caused by terrestrial UEs) to neighboring cells when attached to a serving cell. Serving cell 210A and/or a network element within communications network 125 may use this information to increase the confidence that a UE on the list of possible cellular drones is in fact a drone.

In some embodiments, the interference levels of neighboring cells may be used to initially create a list of possible cellular drones. For example, a list of possible cellular drones may be generated based on interference levels at neighboring cells, and then the RSRP of UEs on the list may be compared to a threshold value to reduce the size of the list of possible cellular drones.

In some embodiments, serving cell 210A or a network element within communications network 125 may cause drone 128 to detach from serving cell 210A, and then measure a change in interference at serving cell 210A. For example, a network element within communications network 125 may command serving cell 210A to detach drone 128 from serving cell 210A. Serving cell 210A may then measure an interference level. If the interference level at serving cell 210A increases as a result of drone 128 being detached, the confidence that drone 128 is in fact a cellular drone increases.

In some embodiments, serving cell 210A or a network element within communications network 125 may cause drone 128 to attach to a different base station. For example, a network element within communications network 125 may allow drone 128 to attach to neighboring cell 220A and then neighboring cell 228 may measure an interference level. If the interference level at neighboring cell 220A drops after drone 128 attaches to neighboring cell 220A, this increases the confidence that drone 128 is in fact a cellular drone.

In general, any number of attach and detach procedures may be performed involving any number of serving cells and neighboring cells, and signal level changes and interference level changes may be compared to one or more thresholds to increase the confidence that a UE being forced to detach and attach is in fact a cellular drone.

In some embodiments, serving cell 210A or a network element in communications network 125 may determine a type of SIM card used by a UE. For example, if a UE suspected to be a cellular drone is using a SIM card registered to a cellular drone, then the UE may be determined to be a legitimate cellular drone. Also for example, if a UE suspected to be a cellular drone is using a SIM card registered to a terrestrial user, and the confidence is high that the UE is in fact a cellular drone, then the UE may be identified to be a nonlegitimate cellular drone. These and other embodiments are further described below.

FIG. 2B is a block diagram illustrating an example, non-limiting embodiment of a list of possible drones communicating with a serving cell in a communications network in accordance with various aspects described herein. List 200B shows a list of UEs attached to serving cell 210A that are suspected to be cellular drones. List 200B may be generated using one or more criterion. For example, in some embodiments, serving cell 210A may compare the RSRP of attached UEs to a threshold value, and UEs having an RSRP above the threshold value may be included in list 200B. Also for example, in some embodiments, list 200B may be generated using changes in interference levels measured at serving cells and/or neighboring cells. A UE that causes an increase in interference at a serving cell when detached from the serving cell may be included in list 200B, as may a UE that causes a decrease in interference in a neighboring cell when the UE attaches to the neighboring cell. Further, a combination of multiple criteria may be used to determine UEs to be included in list 200B. For example, a combination of RSRP values and changes in interference levels when attaching and detaching may be utilized to determine UEs to be included in list 200B.

In some embodiments, list 200B may include all UEs suspected of being cellular drones including legitimate cellular drones and nonlegitimate cellular drones. As shown in FIG. 2B, list 200B includes delivery drone 210B, delivery drone 220B, unknown device 230B, and a survey drone 240B. In some embodiments, delivery drones 210B and 220B, and survey drone 240B may be determined to be legitimate cellular drones based on the type of SIM card used by drones 210B, 220B, and 240B. For example, if SIM cards used by delivery drones 210B, 220B and survey drone 240B are SIM cards registered to a delivery service and a survey service, respectively, specifically for use in cellular drones, then drones 210B, 220B, and 240B may be identified as legitimate cellular drones. Also in some embodiments, suspected cellular drone 230B may be determined to be a nonlegitimate cellular drone based on the type of SIM card used by the drone. For example, if the confidence is high that the UE 230B is a cellular drone, and the UE uses a SIM card registered to a terrestrial user, then UE 230B may be identified as a nonlegitimate drone.

In some embodiments, serving cell 210A or a network element within communications network 125 may take one or more actions in response to identifying a UE as a nonlegitimate drone. For example, a network element within communications network 125 may reduce a bandwidth available to the suspected cellular drone, modify a list of features made available to cellular drone by the communications network, or disconnecting the cellular drone completely.

In some embodiments, an API is exposed to provide a service to users allowing them to subscribe to notifications regarding the identification of cellular drones. For example, a subscribed user may identify a location or a geofenced area via the API. When a drone (legitimate and/or nonlegitimate) is identified at the location or in the geofenced area, the subscribed user may be notified. In some embodiments, the API may allow a subscribed user to specify actions to be taken when a drone is identified (legitimate and/or nonlegitimate). For example, a user may specify a reduction in services to a legitimate drone, and or a complete denial of service to a nonlegitimate drone.

FIG. 2C is a block diagram illustrating an example, non-limiting embodiment of possible routes taken by one or more cellular devices communicating with a communications network in accordance with various aspects described herein. FIG. 2C shows buildings 240C and 242C, roadways 244C, UEs 128 and 220C, and historical travel paths 230C and 232C. In some embodiments, historical travel paths 230C and 232C may be reconstructed from historical records from multiple different base stations. For example, locations of UEs 128 and 220C at different times may be triangulated using power levels received from the UEs 128 and 220C at various base stations.

As shown in FIG. 2C, a historical travel path of a UE may be reconstructed, and that travel path may be used to aid in the identification of suspected cellular drones. For example, UE 128 may have a historical travel path of 230C, and UE220C may have a historical travel path 232C. If UE 128 and UE 220C are both on the list of suspected cellular drones (e.g., list 200B, FIG. 2B), historical travel paths 230C and 232C may aid in determining whether UE 128 and/or UE 220C are in fact cellular drones. Travel path 232C follows a roadway, and so UE 220C may be determined to not be a cellular drone based on the travel path 232C. Travel path 230C may be identified as a flight path based at least in part on the trajectory through buildings and crossing roads and intersecting further buildings. Based on travel path 230C being identified as a flight path, UE 128 maybe identified as a cellular drone. Once identified as a cellular drone, UE 128 may be determined to be either a legitimate cellular drone or a nonlegitimate cellular drone as described herein.

FIGS. 2D-2F depict illustrative embodiments of methods in accordance with various aspects described herein. Referring now to FIG. 2D, at 210D of method 200D, cell towers are monitored for interference. In some embodiments, this corresponds to a network element within communications network 125 monitoring interference levels at a serving cell and neighboring cells. When interference is identified at 220D, nearby cells with interference are identified at 230D. In some embodiments, this may correspond to neighboring cell 220A (FIG. 2A) identifying interference and then identifying interference in neighboring cells 230A and 240A.

At 240D, a drone location is estimated based on interference levels. In some embodiments, this may correspond to triangulating received signal powers received at the various cell towers or base stations to determine locations of UEs causing interference. At 250D, if no nearby towers have low interference, (i.e., all nearby towers have high interference) the UE causing the interference may be determined to be using a different communications network or a different carrier at 260D.

If a nearby tower does have low interference, it may be identified as a serving tower at 270D. This corresponds to determining serving cell 210A (FIG. 2A) as the cell tower or base station that is serving the UE that is suspected of being a cellular drone. At 280D, the UE is identified as a potential UAV or cellular drone based on power levels, such as RSRP levels.

Referring now to FIG. 2E, at 210E of method 200E one or more suspected illegal UAVs are identified. In some embodiments, this corresponds to generating a list of suspected cellular drones, such as list 200B (FIG. 2B). As described above, a list of suspected cellular drones may be generated based on any criteria, including power levels, interference levels, SIM card types, or any other criteria. At 220E, the type of SIM card used by the suspected cellular done is determined. If the SIM card is registered as a cellular drone or UAV, the UE suspected as being a cellular drone is determined to be a legitimate cellular drone at 230E. If the SIM is not registered to a cellular drone, the UE may be ordered to detach from the serving cell at 240E. If the interference at the serving cell does not changes at 250E, then the UE may be determined to not be a cellular drone at 260E. If the interference does change at 250E, then the route or historical travel path of the UE may be analyzed at 270E. Based on the historical travel path, the UE may be determined to be a terrestrial UE or a nonlegitimate cellular drone as described above with reference to FIG. 2C.

The various operations described with reference to FIGS. 2D and 2E may be performed in any order. For example, in FIG. 2E, the type of SIM card is scrutinized prior to detaching the device and measuring changes in interference. In some embodiments, the device is detached prior to scrutinizing the type of SIM card. Further, in FIG. 2E, the type of SIM card and the detachment come after the list of suspected illegal drones has been created. In some embodiments, the list of suspected cellular drones is determined based on the type of SIM card and or a detachment with a change in interference. Further, FIG. 2B shows the route or historical travel path being analyzed last, however in some embodiments it is analyzed earlier in the process.

Referring now to FIG. 2F, at 210F of method 200F, a received signal power associated with a UE attached to a first cellular base station is measured. In some embodiments, this corresponds to measuring the RSRP of a UE attached to a base station such as base station 210A (FIG. 2A). In some embodiments, the RSRP is reported to a network element within a communications network such as communications network 125 (FIG. 1). At 220F, a determination is made that the received signal power is above a first threshold. In some embodiments, the first threshold is determined based on a nominal amaximum power level expected to be received from terrestrial UEs. For example, a cellular drone may be expected to have a higher RSRP than a terrestrial UE, and the first threshold may be selected to differentiate between terrestrial UEs and cellular drones.

At 230F, the UE is detached from the first cellular base station. In some embodiments, this corresponds to a network element within communications network 125 informing the serving base station to detach the UE the from the first cellular base station. At 240F, a change in interference at the first cellular base station is measured. In some embodiments, this corresponds to measuring an interference level prior to the detachment of the UE, and again measuring an interference level after the UE has been detached. In some embodiments, the change in interference at the first cellular base station may be compared to a different threshold. For example, an interference threshold may be selected based on the expected increase in interference when a cellular drown detaches, and the signals transmitted by the cellular drone to a different serving cell represent interference to the base station from which the UE was detached.

At 250F, the UE is attached to a second cellular base station. In some embodiments, this corresponds to a network element within communications network 125 commanding a second cellular base station to accept an attachment request from the UE. Referring now back to FIG. 2A, this detach/attach procedure may correspond to detaching the UE from serving cell 210A and attaching the UE to neighboring cell 220A. At 260F, a change in interference at the second cellular base station is measured. In some embodiments, this corresponds to the second cellular base station measuring interference prior to the attachment of the UE to the second cellular base station, and again measuring an interference level at the second cellular base station after the UE has attached to the second cellular base station. In some embodiments, the change in interference is compared to yet another threshold. This threshold may be selected based on an expected change in interference when the UE signal which represented interference prior to the attachment of the UE to the second cellular base station is now no longer part of the interference because it is a signal that is being used to communicate directly with the second cellular base station.

At 270F, a travel path of the UE is reconstructed. In some embodiments, this travel path may be reconstructed using historical received power levels at various base stations and/or cell towers. For example, once a UE is selected as a suspected cellular drone, historical records may be retrieved from the various base stations and the historical locations of the UE may be reconstructed by triangulating received signal powers. In some embodiments, the historical travel path is determined to be a flight path. For example, as described above with reference to figure to see, a historical travel path that does not conform to a normal terrestrial UE travel pattern maybe determined to be a flight path, and a UE with this historical travel path may be determined to be a cellular drone.

At 280F, a type of SIM card used by the UE is determined. In some embodiments, the type of SIM card may be used to determine whether a suspected cellular drone is a legitimate cellular drone or a nonlegitimate cellular drone. For example, if a suspected cellular drone uses a SIM card registered for use in a drone, then the suspected cellular drone may be determined to be a legitimate cellular drone. In contrast, if a suspected cellular drone uses a SIM card associated with a terrestrial user, yet confidence is high that the UE using that particular SIM card is in fact a cellular drone, the UE may be identified as a nonlegitimate cellular drone at 290F.

While for purposes of simplicity of explanation, the respective processes are shown and described as a series of blocks in FIGS. 2D-2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

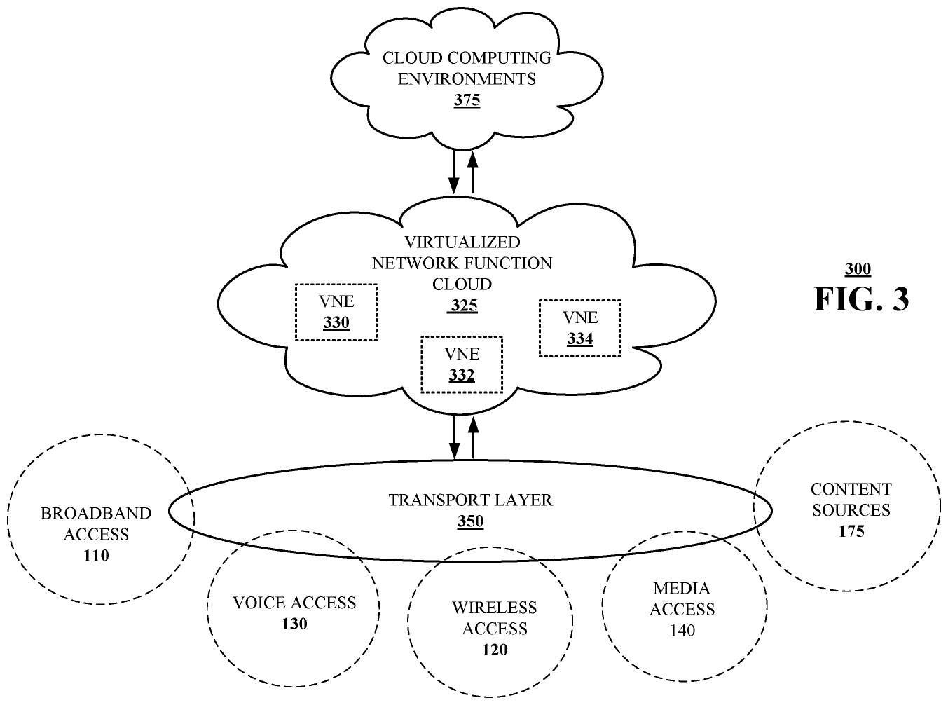

Referring now to FIG. 3, a block diagram 300 is shown illustrating an example, non-limiting embodiment of a virtualized communication network in accordance with various aspects described herein. In particular a virtualized communication network is presented that can be used to implement some or all of the systems, subsystems, functions, and methods described herein. For example, virtualized communication network 300 can facilitate in whole or in part the identification of cellular drones.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

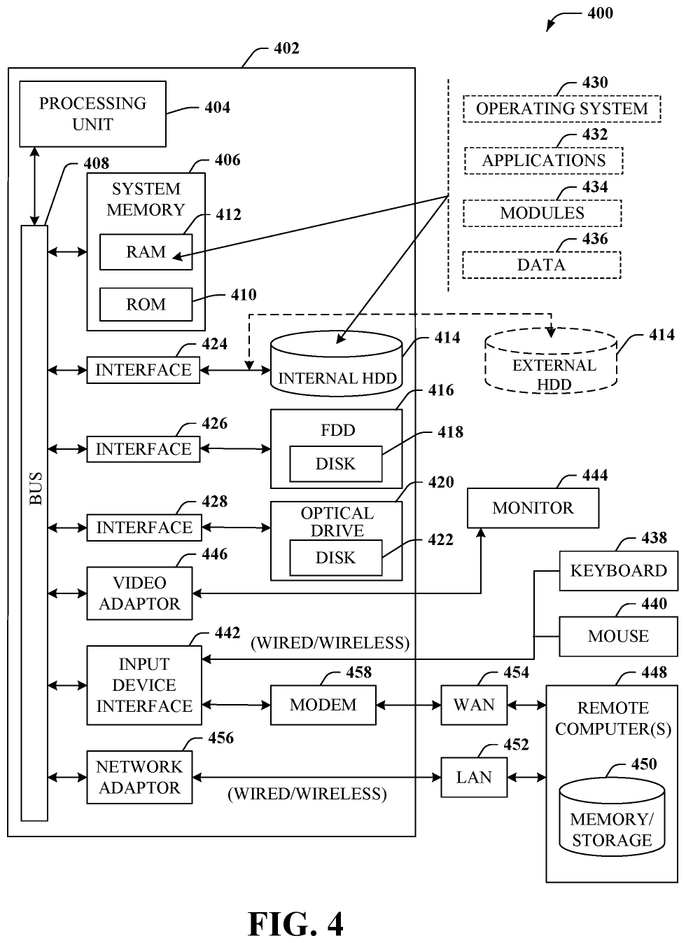

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part the identification of cellular drones.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

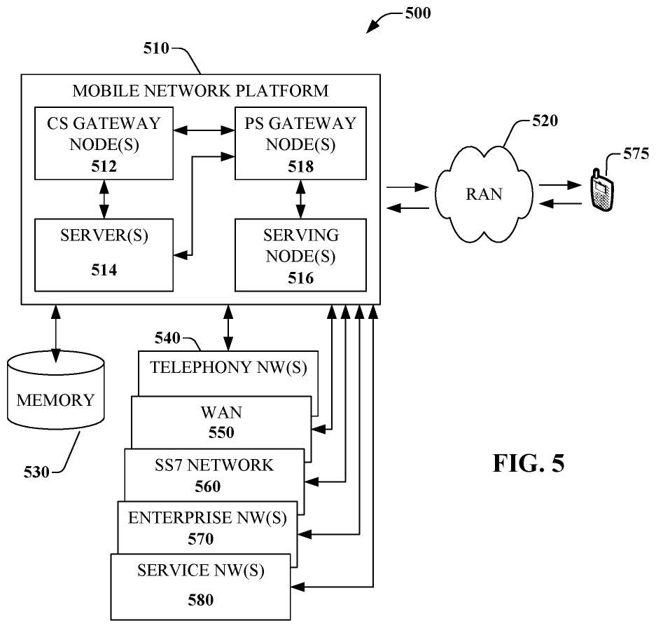

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part the identification of cellular drones. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

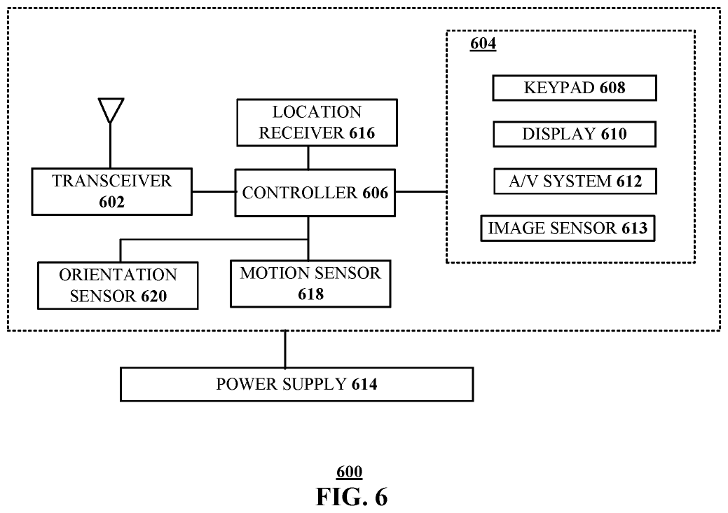

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part the identification of cellular drones.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
measuring a received signal power associated with a user equipment attached to a first cellular base station;
determining that the received signal power is above a first threshold;
detaching the user equipment from the cellular base station; and
identifying the user equipment as a drone based at least in part on a change in measured interference that occurs at the first cellular base station when the user equipment is detached from the first cellular base station.

2. The device of claim 1, wherein the identifying the user equipment as a drone based at least in part on the change in measured interference comprises:
measuring an increase in interference; and
comparing the increase in interference to a second threshold.

3. The device of claim 1, wherein the operations further comprise attaching the user equipment to a second cellular base station, and wherein the identifying the user equipment as a drone is further based on a further change in measured interference that occurs at the second cellular base station when the user equipment is attached to the second cellular base station.

4. The device of claim 1, wherein the identifying the user equipment as a drone is further based on a type of SIM card used by the user equipment.

5. The device of claim 4, wherein the operations further comprise identifying the drone as a nonlegitimate drone based on the type of SIM card.

6. The device of claim 5, wherein the operations further comprise denying communications services to the nonlegitimate drone.

7. The device of claim 1, wherein the operations further comprise providing information regarding the user equipment using an application programming interface (API).

8. The device of claim 1, wherein the operations further comprise reconstructing a travel path of the user equipment.

9. The device of claim 8, wherein the operations further comprise identifying the travel path as a flight path.

10. The device of claim 9, wherein the identifying the user equipment as a drone is further based on the identifying the travel path as a flight path.

11. A non-transitory machine-readable medium, comprising executable instructions that, when executed by a processing system including a processor, facilitate performance of operations, the operations comprising:
generating a list of possible cellular drones, wherein the list includes user equipments (UEs) having measured signal powers above a first threshold; and
determining at least one UE on the list is a nonlegitimate drone based at least in part on a type of SIM card used by the at least one UE.

12. The non-transitory machine-readable medium of claim 11, wherein the determining the at least one UE on the list is a nonlegitimate drone comprises determining the at least one UE uses a SIM card intended for terrestrial use.

13. The non-transitory machine-readable medium of claim 11, wherein the determining the at least one UE on the list is a nonlegitimate drone comprises:
detaching the at least one user equipment from a first cellular base station; and
determining that a change in measured interference that occurs at the first cellular base station when the user equipment is detached from the first cellular base station is above a second threshold.

14. The non-transitory machine-readable medium of claim 11, wherein the operations further comprise denying communications services to the nonlegitimate drone.

15. The non-transitory machine-readable medium of claim 11, wherein the operations further comprise providing information regarding the nonlegitimate drone using an application programming interface (API).

16. A method, comprising:
measuring, by a processing system including a processor, a received signal power associated with a user equipment attached to a first cellular base station;
determining, by the processing system, that the received signal power is above a first threshold;
detaching, by the processing system, the user equipment from the cellular base station; and
identifying, by the processing system, the user equipment as a drone based at least in part on a change in measured interference that occurs at the first cellular base station when the user equipment is detached from the first cellular base station.

17. The device of claim 16, wherein the operations further comprise providing, by the processing system, information regarding the user equipment using an application programming interface (API).

18. The device of claim 16, wherein the operations further comprise reconstructing, by the processing system, a travel path of the user equipment.

19. The device of claim 18, wherein the operations further comprise identifying, by the processing system, the travel path as a flight path.

20. The device of claim 19, wherein the identifying the user equipment as a drone is further based on the identifying the travel path as a flight path.
